(19) United States
(12) Patent Application Publication
(10) Pub. No.: US 2012/0172050 A1
(43) Pub. Date: Jul. 5, 2012

(54) METHOD AND APPARATUS FOR CONTEXT BASED ON SPATIAL TRAILS

(75) Inventors: Jonathan Ledlie, Cambridge, MA (US); Leo Kärkkäinen, Helsinki (FI); Pentti Valtteri Niemi, Naantali (FI)

(73) Assignee: Nokia Corporation, Espoo (FI)

(21) Appl. No.: 12/980,864

(22) Filed: Dec. 29, 2010

(51) Int. Cl. H04W 4/02

(52) U.S. Cl. 455/456.1

(57) ABSTRACT

Techniques for determining context based on a spatial trail include determining data that indicates a first trail comprising a plurality of locations of finite spatial granularity at a corresponding plurality of times. The techniques also comprise determining data that indicates at least one criterion for belonging in a group. The criterion indicates a first spatial granularity for at least a first location at a corresponding first time in the first trail. The techniques further comprise determining whether a particular entity belongs in the group based, at least in part, on the criterion and a second trail for the particular entity. A trail for any entity comprises a plurality of locations of finite spatial granularity indicating actual locations of the entity at a corresponding plurality of times.

### BACKGROUND

Service providers and device manufacturers (e.g., wireless, cellular, etc.) are continually challenged to deliver value and convenience to consumers by, for example, providing compelling network services. One group of network services provides context aware services that determine user location or activity context to adapt interfaces, tailor the set of application-relevant data, connect users with similar contexts, increase the precision of information retrieval, discover services, make the user interaction implicit, build smart environments, or direct advertisements to receptive individuals. Many applications determine the user's context, at least in part, based on the user's current location. However, as the precision of a user's location becomes greater, threats to the person's privacy and security can increase. Furthermore, a proper context may depend not only on the person's current location, or any single past location, but also on some combination of multiple locations in a particular temporal order, e.g., a trail of one or more users.

### SOME EXAMPLE EMBODIMENTS

Therefore, there is a need for an approach for determining user context based on a spatial trail, for example, to define groups of entities that share data.

According to one embodiment, a method comprises determining data that indicates a first trail comprising a plurality of locations of finite spatial granularity at a corresponding plurality of times. The method also comprises determining data that indicates at least one criterion for belonging in a group, wherein the criterion indicates a first spatial granularity for at least a first location at a corresponding first time in the first trail. The method further comprises determining whether a particular entity belongs in the group based, at least in part, on the criterion and a second trail for the particular entity, wherein a trail for any entity comprises a plurality of locations of finite spatial granularity indicating actual locations of the entity at a corresponding plurality of times.

According to another embodiment related to a user experience, a method comprises causing, at least in part, actions that result in presenting at least one user interface. The user interface indicates a trail in a first dimension and spatial granularity in a different second dimension. The trail comprises a plurality of locations at a corresponding plurality of times. The user interface also indicates an active area that allows a user to change the spatial granularity of the trail for at least a first location of the plurality of locations at a corresponding first time.

According to another embodiment, an apparatus comprises at least one processor, and at least one memory including computer program code, the at least one memory and the computer program code configured to, with the at least one processor, cause, at least in part, the apparatus to determine data that indicates a first trail comprising a plurality of locations of finite spatial granularity at a corresponding plurality of times. The apparatus is also caused to determine data that indicates at least one criterion for belonging in a group. The criterion indicates a first spatial granularity for at least a first location at a corresponding first time in the first trail. The apparatus is further caused to determine whether a particular entity belongs in the group based, at least in part, on the criterion and a second trail for the particular entity. A trail for any entity comprises a plurality of locations of finite spatial granularity indicating actual locations of the entity at a corresponding plurality of times.

According to another embodiment, a computer-readable storage medium carries one or more sequences of one or more instructions which, when executed by one or more processors, cause, at least in part, an apparatus to determine data that indicates a first trail comprising a plurality of locations of finite spatial granularity at a corresponding plurality of time. The apparatus is also caused to determine data that indicates at least one criterion for belonging in a group. The criterion indicates a first spatial granularity for at least a first location at a corresponding first time in the first trail. The apparatus is further caused to determine whether a particular entity belongs in the group based, at least in part, on the criterion and a second trail for the particular entity. A trail for any entity comprises a plurality of locations of finite spatial granularity indicating actual locations of the entity at a corresponding plurality of times.

According to another embodiment, an apparatus comprises means for determining data that indicates a first trail comprising a plurality of locations of finite spatial granularity at a corresponding plurality of times. The apparatus also comprises means for determining data that indicates at least one criterion for belonging in a group. The criterion indicates a first spatial granularity for at least a first location at a corresponding first time in the first trail. The apparatus further comprises means for determining whether a particular entity belongs in the group based, at least in part, on the criterion and a second trail for the particular entity. A trail for any entity comprises a plurality of locations of finite spatial granularity indicating actual locations of the entity at a corresponding plurality of times.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: an apparatus comprising means for performing the method of any of originally filed claims 1-12, 21-45, and 50-52.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining context based on a spatial trail, according to one embodiment;

FIG. 2A is a diagram of a subscriber messages data structure, according to one embodiment;

FIG. 2B is a diagram of a trail data structure, according to one embodiment;

FIG. 2C is a diagram of a location granularity hierarchy, according to an embodiment;

FIG. 2D is a diagram of a spatial groups data structure, according to an embodiment;

FIG. 2E is a diagram of a request message, according to an embodiment;

FIG. 3 is a flowchart of a process for a spatial groups client, according to one embodiment;

FIGS. 4A-4B are diagrams that illustrate trail data, according to various embodiments;

FIGS. 4C-4G are diagrams of user interfaces utilized in the processes of FIG. 3, according to various embodiments;

FIG. 5 is a flowchart of a process for a spatial groups service, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program are disclosed for determining context based on a spatial trail. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term trail refers to multiple locations of finite spatial granularity at a corresponding plurality of times. The multiple locations of the trail may be sorted into temporal order; and are assumed to be so sorted in the following embodiments, unless otherwise indicated. An entity refers to an object whose context is to be determined, whether a package, a vehicle, an animal, a person, a group of such things, or a user of any network service, whether the user is a person or an organization of multiple persons. A trail for an entity refers to a plurality of locations of finite spatial granularity indicating actual locations of the entity at a corresponding plurality of times. In some embodiments, a trail includes hypothetical locations and times, such as for guessed or planned movements.

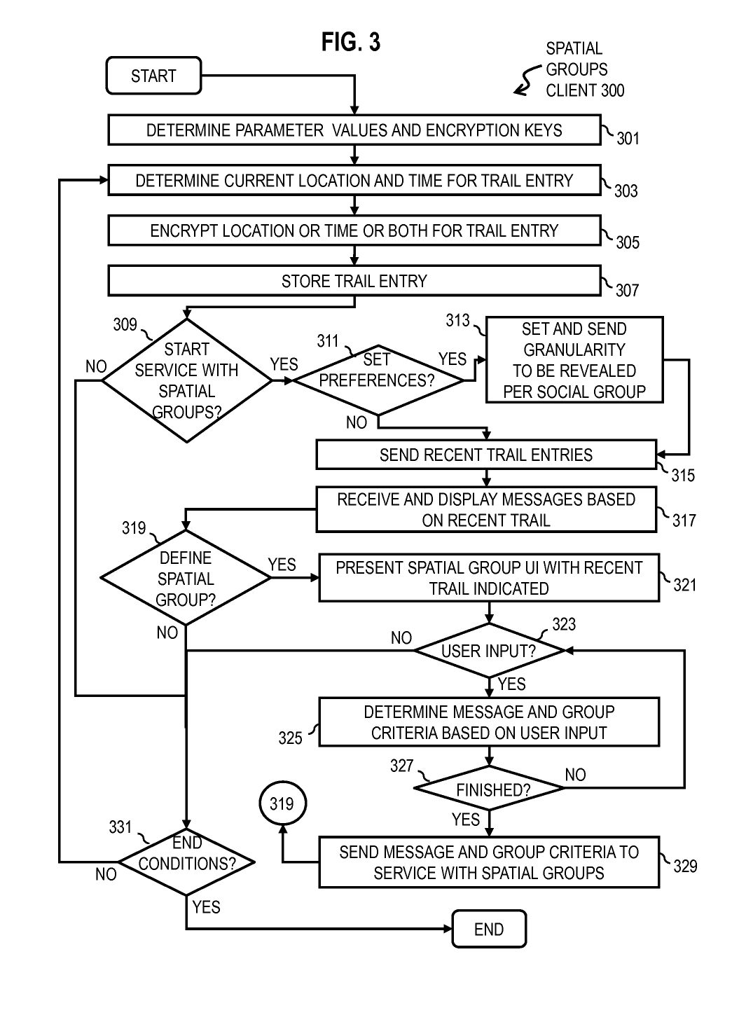

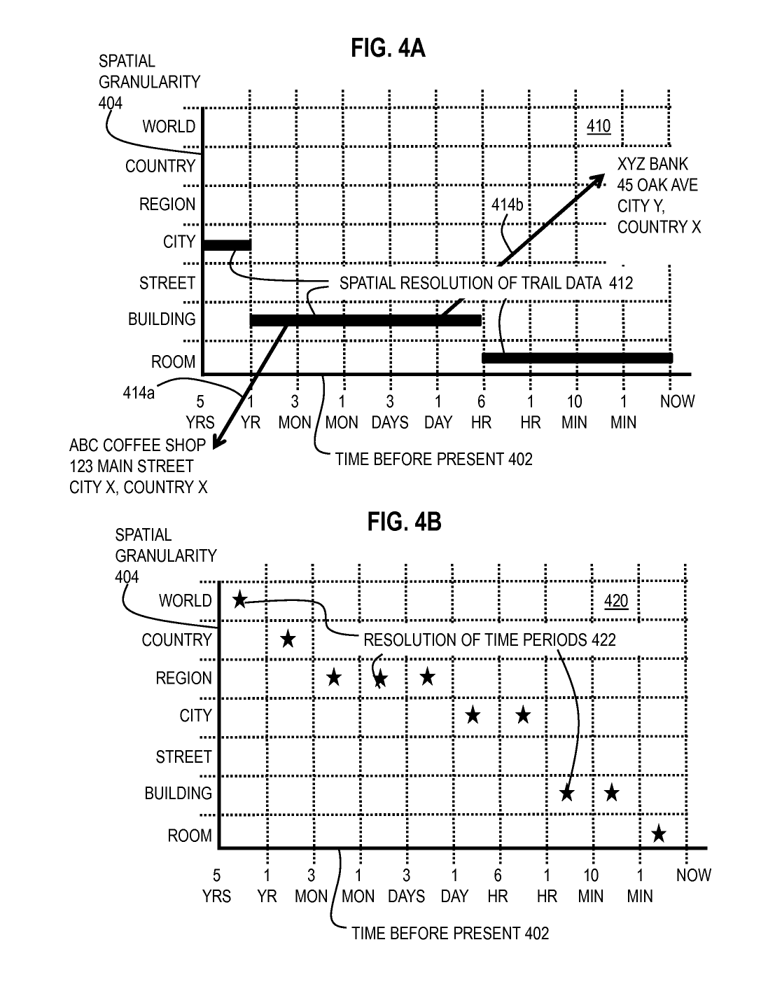

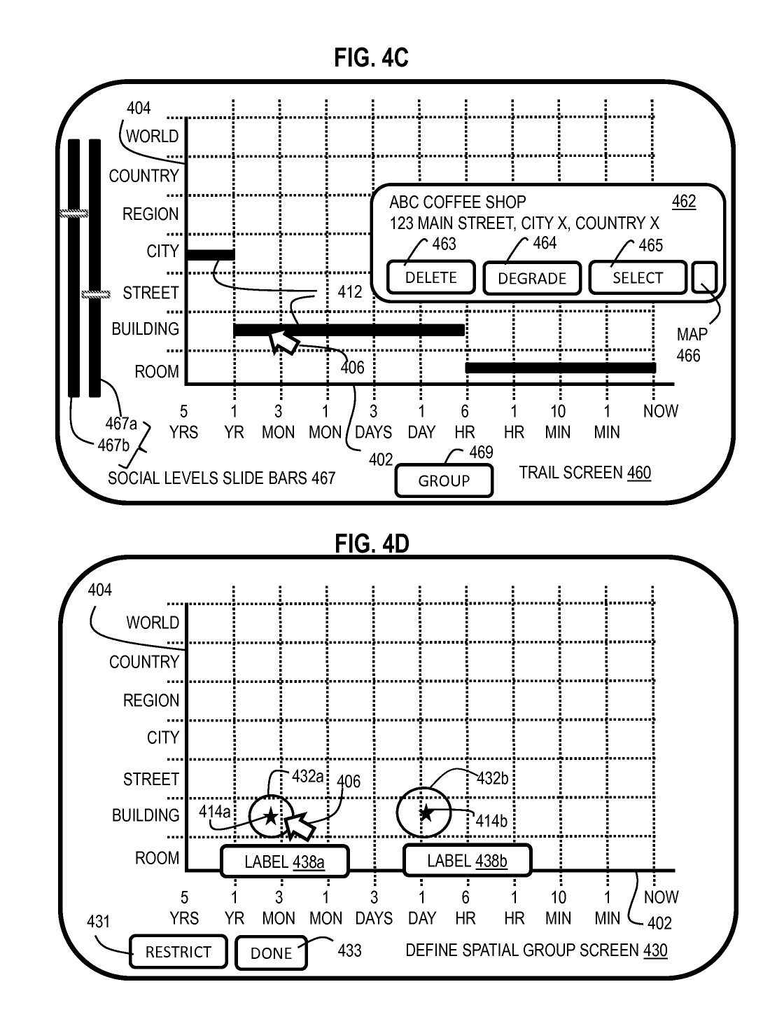

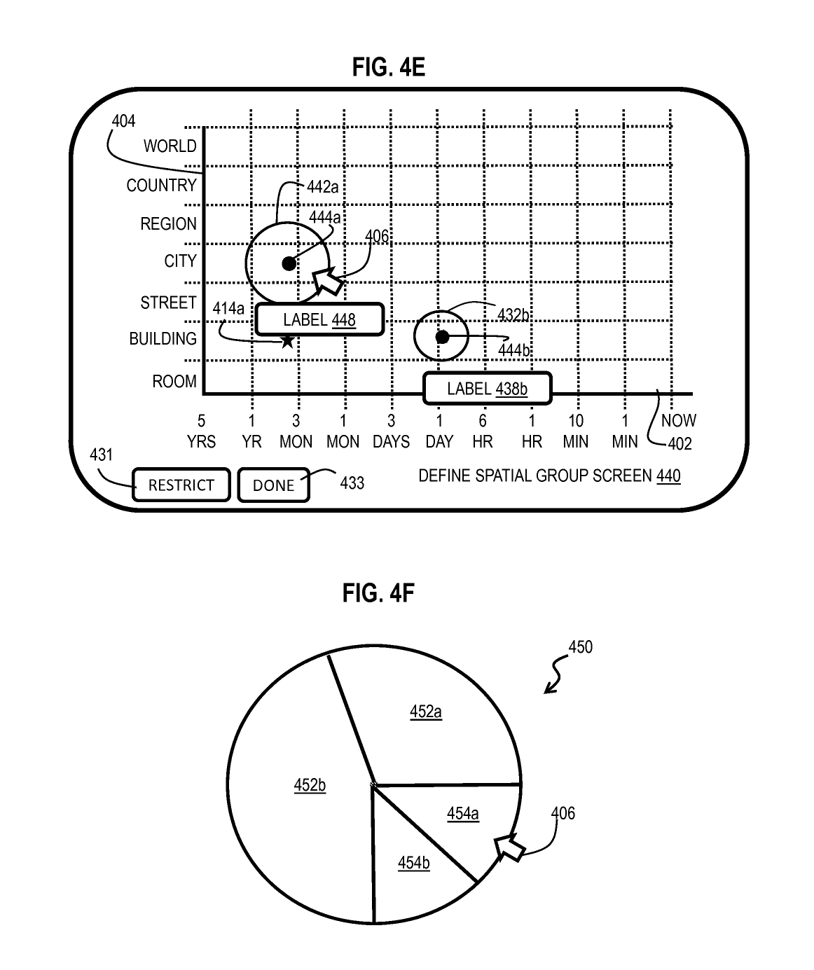

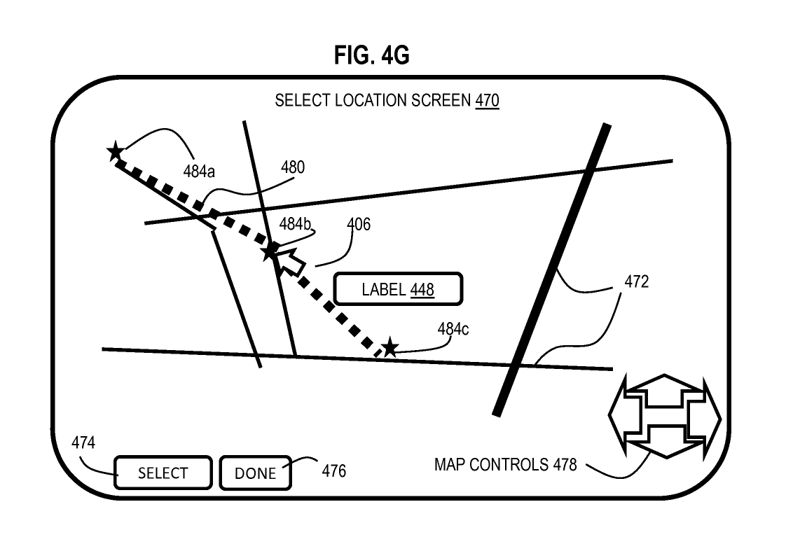

Although various embodiments are described with respect to sending messages among entities of a group who share a common spatial context based on the trails for those entities who subscribe to a particular service and for which the least coarse finite spatial granularity is a room in a building, it is contemplated that the approach described herein may be used for other functions, such as sharing data or access to one or more services or receiving advertisements or other services related to the spatial context of the group, and for groups defined based on any trail, including one or more hypothetical trails or trails of entities outside the particular service, with more or less coarse spatial granularity. The user experience is described for some embodiments with respect to the method in FIG. 3 and user interfaces depicted in FIG. 4C through FIG. 4G.

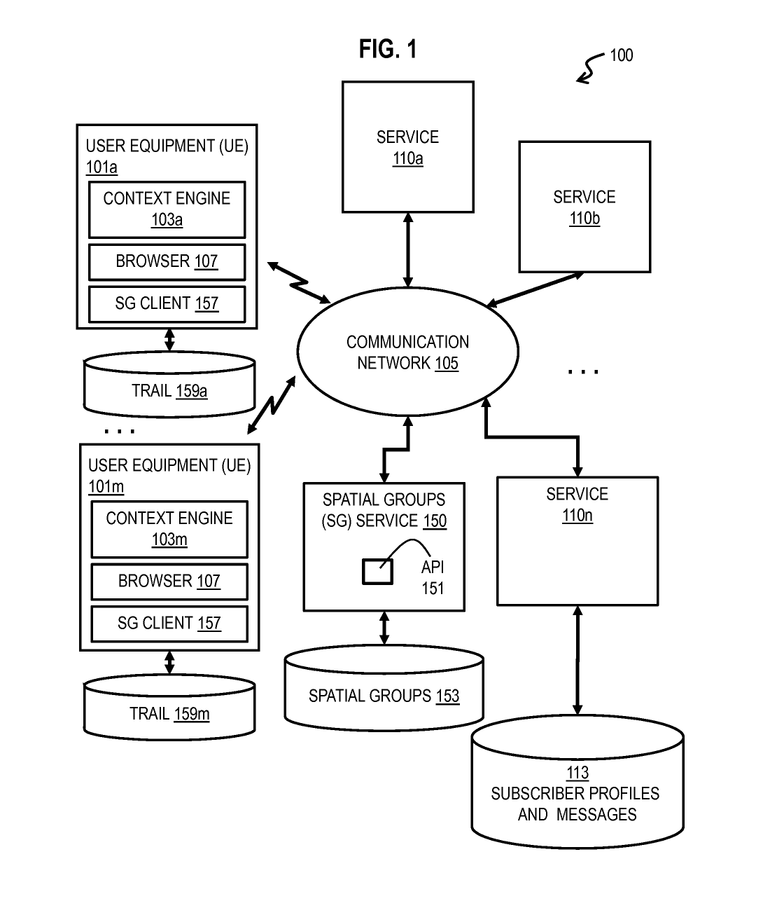

FIG. 1 is a diagram of a system 100 capable of determining context based on a spatial trail, according to one embodiment. Many instances of user equipment, such as user equipment (UE) 101a through UE 101m (collectively referenced hereinafter as UE 101) include a process, such as context engines 103a through 103m, respectively (collectively referenced hereinafter as context engines 103), that determines location data that indicates a spatial location of the UE 101. For example, on a mobile UE 101, a communications process determines an identifier for a base tower with the strongest received signal at a moment of time, which indicates that the UE 101 is within a coverage cell of that base tower (an area on the order of several square kilometers). For example, on a mobile UE 101 with a WiFi network interface card, a process determines an identifier for an access point with the strongest received signal at a moment of time, which indicates that the UE 101 is within a coverage cell of that access point (an area on the order of one hundredth of a square kilometer). Similarly, a wired UE 101 connects to the communication network 105 with a fixed network address that indicates, for example, a city block or building or room, where the UE is located. Alternatively, on a UE 101 equipped with a global positioning system (GPS) receiver, the position of the UE is determined within a few square meters. Any of this location information can be communicated to one or more network services 110a, 110b through 110n (collectively referenced hereinafter as network services 110), for example, by means of communication network 105, to determine the user's spatial context and, consequently, the appropriate context-aware service.

However, a user may not wish to divulge the finest resolution location, to avoid stalking by strangers or hackers, or intrusion by colleagues or family members. Furthermore, the user may want to define a group of entities, such as other subscribers of a particular service 110 (such as service 110a), who shared multiple locations over a particular time interval, in order to share a message or other data. For example, the user may wish to determine all the attendees of a meeting held in a conference city on the previous day who are in the user's different home city today, to invite them to a soiree on a similar subject at a local coffee house. Previous approaches do not allow a spatial context, or a group of entities with similar spatial context, to be defined based on multiple past positions, e.g., based on similarity of the trails for two or more entities.

To address this problem, a system 100 of FIG. 1 introduces the capability to determine context based on a spatial trail, and to perform functions, such as sending messages, involving groups of entities with similar trail-based contexts, without divulging the identities of the entities to each other. A further degree of security is provided, in some embodiments, by requiring that an entity defining a group must be a member of the group. For example, the user must have been present at one or more of the locations requested at the corresponding times. This further precaution offers the advantage of preventing harassment of certain entities (such as famous persons whose trail is reported in the press) by entities that had no business on that certain entity's trail, e.g., could not have met. In some embodiments, the system 100 further protects the privacy of the entity's travels by encrypting any location data sent from the UE 101. In addition, some embodiments provide a user interface that allows the user to discern and easily define a context, or group of entities with similar context, based on spatial trails.

The system 100 thus provides access to people with a similar location history. For example, the system 100 allows sharing of party photos with all the people who attended a party. As further examples, the system 100 allows: notifying people who passed through a spot where a wallet was found; setting up a telephone conference with people who were in Finland last week, but are now in the US. In some embodiments, the system 100 also provides targeted advertisements and coupons. For example, a specific coupon can be sent to persons who visit store A before going to store B, e.g., by store A to induce the person to come back, or by store B to induce the person not to go back. In other examples, a user send a message to those subscribers who might have found his cell phone; or sends a message to persons who might be the person the user spoke to at an airport.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

As shown in FIG. 1, the system 100 comprises UE 101 having connectivity to network services 110 and spatial groups (SG) service 150 via a communication network 105. By way of example, the UE 101 and hosts for the SG service 150 and network services 110 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Processes executing on various devices, called hosts, often communicate using the client-server model of network communications, widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” and “service” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. A well known client process available on most devices connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages.

The capabilities for system 100 are provided by one or more processes, including a spatial groups (SG) service 150 or a spatial groups (SG) client 157 or a browser 107 or context engine 103 or network services 110 or some combination, executing on one or more hosts connected to network 105.

On each UE 101, a context engine 103 determines a location and time for the UE that is used to construct a trail for the UE. A SG client 157 on each UE 101 receives the location data from the context engine 103, determines an entry for the trail, changing granularity of the location information as desired, and stores the next entry for the trail. Data indicating the trail for UE 101a through 101m is stored in trail data structure 159a through 159m, respectively (collectively referenced hereinafter as trail data structure 159). Input from a user of UE 101 to define criteria for a group with similar trail-based contexts is received at the SG client 157 through a UI interface presented by the SG client, either directly, or through browser 107.

The network services 110 provide services for users of UE 101. Some services 110 involve users registering with the service 110 by providing information about themselves, such as a user identifier, an email address or cell phone number, a gender, a birth year, and topics of interest within the service for each user. Such registered users are called subscribers herein. This information is stored in subscribers profiles data structures. Messages sent by subscribers to other subscribers through the service 110 are also maintained by the services 110. For example, service 110n stores subscriber profile information and subscriber provided messages in data structure 113.

According to the illustrated embodiment, a spatial groups (SG) service 150 determines criteria for a group, e.g., based on user input detected by SG client 157, and determines if the spatial trail of a subscriber satisfies the group criteria. The group definitions are stored in the spatial groups data structure 153. In the illustrated embodiment, the functionality of the SG service 150 is accessed by the services 110 and SG clients 157 through the SG application programming interface (API) 151. In some embodiments, the user interface (UI) for specifying group criteria is generated by the SG service 150 and presented at the UE 101 by the SG client 157 or browser 107.

Although processes, equipment, and data structures are depicted in FIG. 1 as integral blocks in a particular arrangement for purposes of illustration, in other embodiments one or more processes or data structures, or portions thereof, are arranged in a different manner, on the same or different hosts, in one or more databases, or are omitted, or one or more different processes or data structures are included on the same or different hosts. For example, in FIG. 1, the SG service 150 is separate from any service 110 and the SG client 157 is separate from the browser 107. It is contemplated that the functions of these components may be combined in one or more components or performed by other components of equivalent functionality.

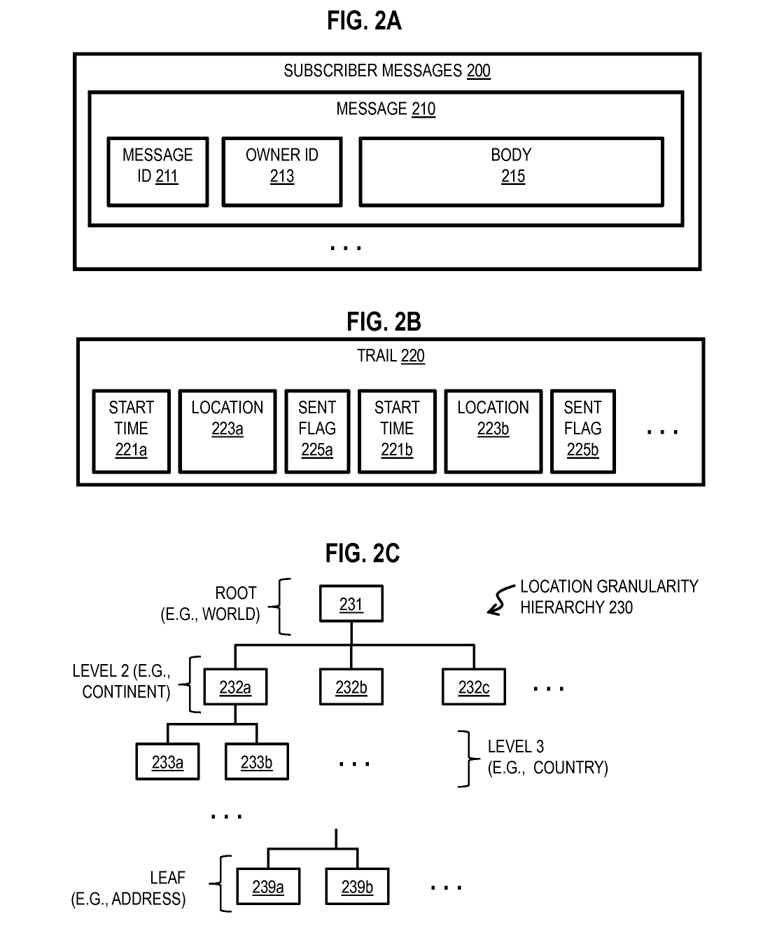

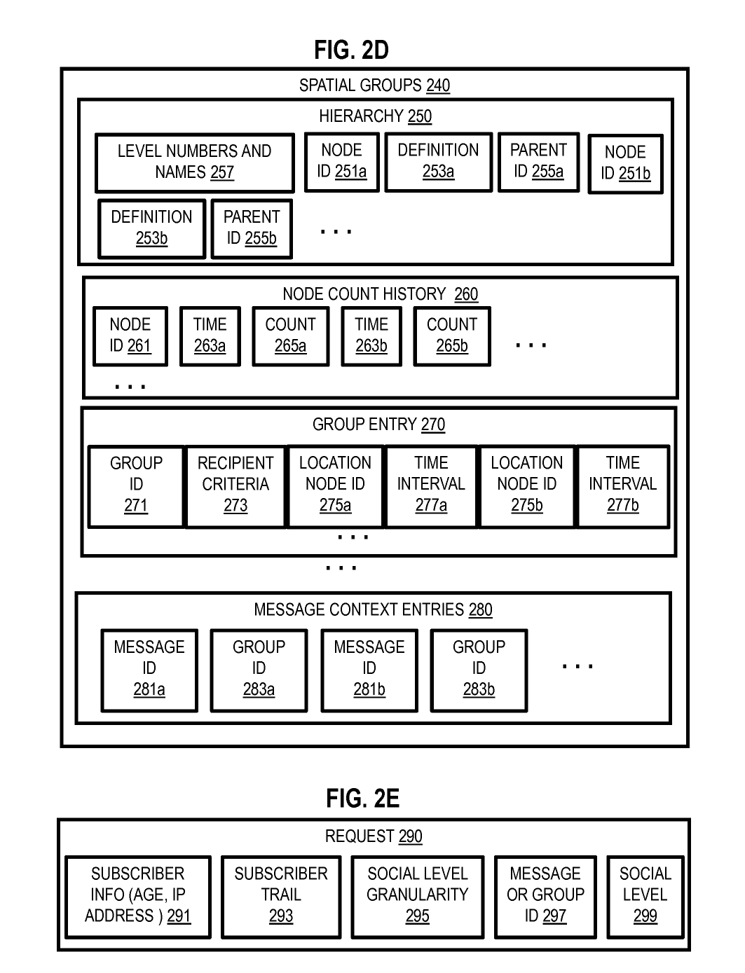

FIG. 2A is a diagram of a subscriber messages data structure 200, according to one embodiment. For example, in some embodiments, the subscriber messages data structure 200 is maintained in the subscriber profiles and messages data structure 113. In other embodiments, subscriber messages data structure 200, or portions thereof, is stored in the spatial groups data structure 153.

Subscriber messages data structure 200 includes a message field 210 for each message provided by a subscriber of one or more services, where the ellipsis indicates other message fields. Each message field 210 includes a message identifier (ID) field 211, an owner identifier (ID) field 213 and a body field 215.

The message ID field 211 holds data that uniquely indicates an individual message among all the messages stored in the subscriber messages data structure 200, for example with a sequential number or a date time stamp. The owner ID fields hold data that uniquely indicates a subscriber who provided the message. The data in field 213 is used to determine, in some embodiments, whether the message can be delivered to persons who are not contacts of the owner. The body field 215 holds data that indicates the contents of the message, such as text, fonts, images, audio clips, game data, video clips, etc. for one or more contents assembled in a thread comprising one posting and one or more rounds of replies.

Although data structures, messages and fields are depicted in FIG. 2A, and subsequent diagrams in FIG. 2B through FIG. 2E, as integral blocks in a particular order for purposes of illustration, in other embodiments, one or more data structures or messages or fields, or portions thereof, are arranged in a different order, in the same or different number of data structures or databases in one or more hosts or messages, or are omitted, or one or more additional fields are included, or the data structures and messages are changed in some combination of ways.

FIG. 2B is a diagram of a trail data structure 220, according to one embodiment. For example, in some embodiments, the trail data structure 220 is a particular embodiment of the trail data structure 159 maintained by the UE 101. In other embodiments, trail data structure 220, or portions thereof, is stored in the spatial groups data structure 153; and, a separate trail data structure 220 is maintained for each different subscriber.

The trail data structure 220 includes start time fields 221a, 221b, among others indicated by ellipsis, collectively referenced hereinafter as start time fields 221. The trail data structure 220 also includes, corresponding to start time fields 221a, 221b, among others, location fields 223a, 223b, among others indicated by ellipsis, collectively referenced hereinafter as location fields 223. In some embodiments, the trail data structure 220 further includes, corresponding to start time fields 221a, 221b, among others, sent flag fields 225a, 225b, among others indicated by ellipsis, collectively referenced hereinafter as sent flag fields 225.

Each location field 223 holds data that indicates a geographic position of the UE 101 associated with the data structure 220, or of the subscriber associated with the UE 101, at a limited degree of granularity, called herein a finite spatial granularity. The degree of granularity is limited to avoid updating the trail data structure frequently and overloading the storage and processing capacity of a host device with insignificant position changes, such as from one end of a room to another, or one part of a building to the next. In some embodiments, the degree of granularity is limited to avoid giving away too much detail that the user of UE 101 considers private, such as a particular building on a street or city block. Thus, the finite spatial granularity of the trail is selected to provide a degree of privacy for the entity. In some embodiments, the levels of granularity from which to select are predetermined by a granularity hierarchy, as described in more detail below with reference to FIG. 2C. In some such embodiments, the location field holds data that indicates the node in the hierarchy. Thus, the finite spatial granularity of a trail is selected from a plurality of predetermined finite spatial granularities of the hierarchy. In some embodiments the location fields hold encrypted data, called ciphers, which are meaningless on their face but can represent the same nodes in the hierarchy to someone who has the key to decrypt the cipher and recover the un-encrypted location data. Thus, in such embodiments, the plurality of locations in any trail and the first location in the criterion are encrypted with a homomorphic encryption that preserves membership in locations of finer or coarser granularity. In particular, this means that it is possible to deduce from the encrypted data that two or several encrypted data items relate to the same location trail or to several locations in the specified hierarchy level of the trail.

The start time field 221 holds data that indicates a time when the UE 101 associated with the data structure 220, or the subscriber associated with the UE 101, became associated with the geographical position indicated in the corresponding location field 223 at the corresponding granularity. In some embodiments, the time also has a finite granularity and position changes that persist for less than a minimum time interval, such as ten seconds, are not recorded. In some embodiments, the start time is not used, and the time that the UE 101 left the node of the spatial granularity hierarchy is recorded in field 221 instead.

The sent flag field 225 hold data that indicates whether the time and location data in the corresponding start time field 221 and location field 223, respectively, have been sent to the SG service 150. In some embodiments, the SG service 150 stores the individual trails of many subscribers in the spatial groups data structure 153. In such embodiments, it saves network bandwidth and processing capacity at the host of the service 150 to avoid sending the same time and location entries multiple times. In such embodiments, the sent flag field 225 is included and holds data that indicates whether the time and lotion data have already been sent to the SG service 150 (either directly or indirectly through a network service 110). For example, the sent flag field 225 is one bit that holds a zero if the corresponding time and location have not been sent, a value of 1 if the corresponding time and location have been sent. As another example, the sent flag field 225 is one octet (8 bits) that holds a logical “FALSE” value if the corresponding time and location have not been sent, and a logical “TRUE” value if the corresponding time and location have been sent. In some embodiments, the SG service 150 also maintains counts of number of trails that pass through each position of finite granularity in particular time intervals. In such embodiments, the sent flag field help prevent counting the previously sent positions again. In some embodiments, the sent flag fields 225 are omitted.

The trail data structure 220 represents a trail for a particular user of UE 101. Thus, a trail for any entity comprises a plurality of locations of finite spatial granularity indicating actual locations of the entity at a corresponding plurality of times. In other embodiments, the trail data structure 220 hold a trail for a different subscriber or public figures or a hypothetical trail that might not have actually been followed by any known entity.

FIG. 2C is a diagram of a location granularity hierarchy 230, according to an embodiment. The hierarchy 230 is described in terms of a tree of nodes, each node (except the root node) having a single parent node but an unlimited number of child nodes. The location of the parent node includes the locations of all the child nodes. The final descendent nodes constitute the leaf nodes which are associated with the finest level of spatial granularity. The levels of location granularity are predetermined by the location granularity hierarchy 230. Thus, the finite spatial granularity for recording a location in a trail is selected from a plurality of predetermined finite spatial granularities. The granularity of each location is finite and no finer than the finest granularity in the predetermined set of granularities.

For example, at the root node 231 is the coarsest geographic position, e.g., the world, at the first level of granularity. At the second level is the next coarsest granularity, such as continent-scale location, of which there are several nodes 232a, 232b, 232c among others indicated by ellipsis (collectively referenced hereinafter as level two nodes 232). Each node at the continent level has the root node, e.g., world, as a parent. Each successive level of nodes introduces a finer degree of granularity. For example, the third level represents the country level of location granularity including nodes 233a, 233b among others indicted by ellipsis (collectively referenced hereinafter as level three nodes 233). Each country node 233 has a continent node 132 as a parent. The hierarchy continues through one or more levels indicated by ellipsis to the finest level of granularity at the leaf nodes 239a, 239b among others indicated by ellipsis (collectively referenced hereinafter as leaf nodes 239). In the illustrated embodiment, the street address (e.g., a suite within a building) is the finest. In other embodiments, the finest level of spatial granularity is even finer, e.g., at the room level within a suite.

In other embodiments, a different location granularity hierarchy is used, such as a hierarchy starting a root node indicating the world, a next level indicating latitude-longitude quadrant, another level indicating latitude-longitude ten degree quadrilaterals, another level indicating latitude-longitude one degree quadrilaterals, and leaf nodes indicating GPS position truncated to 0.01 degrees. In some embodiments, multiple different granularity hierarchies are used, such as a different hierarchy for different network services. In some embodiments, a transformation is determined to translate a node in one hierarchy associated with a user location to a corresponding node in a different hierarchy. In some embodiments, the hierarchy and translations are changed or otherwise updated, e.g., to accommodate a change in the address/location of a building's name.

In some embodiments, the value in the location field 223 is expressed as an un-encrypted or encrypted identifier for a particular node in the spatial granularity hierarchy 230, or a location value associated with that node. Such an arrangement automatically achieves a finite spatial granularity for the locations indicated by a trail.

FIG. 2D is a diagram of a spatial groups data structure 240, according to an embodiment. In some embodiments, the spatial groups data structure 240 is a particular embodiment of the spatial groups data structure 153 maintained by the SG service 150. In other embodiments, one or more fields of spatial groups data structure 240, or portions thereof, are stored in the network services 110, e.g., alongside subscriber profiles and messages data structure 113 or at the UE 101, such as alongside trails data structure 159. In the illustrated embodiment, the spatial groups data structure 240 includes a hierarchy field 250, a node count history field 260, one or more group entry fields 270, and a message context entries field 280.

The hierarchy field 250 holds data that indicates the spatial granularity hierarchy used for determining spatial context, such as hierarchy 230. The hierarchy field 250 includes node ID fields 251a, 251b, among other indicated by ellipsis (collectively referenced hereinafter as node ID fields 251), definition fields 253a, 253b, among other indicated by ellipsis (collectively referenced hereinafter as definition fields 253), and parent ID fields 255a, 255b, among others indicated by ellipsis (collectively referenced hereinafter as parent ID fields 255). For each node in the hierarchy, the hierarchy field 250 includes a node ID fields 251, a corresponding definition field 253 and a corresponding parent ID field 255. In the illustrated embodiment, the hierarchy field 250 includes a level numbers and names field 257 for the predetermined levels of the hierarchy, which represent the different degrees of spatial granularity.

The node ID field 251 holds data that uniquely indicates the node in the hierarchy, such as a sequential number among all the nodes in the hierarchy, or a level number and sequence number for the node within a level. The definition field 253a holds data indicates how the node is defined, e.g., the bounding latitudes and longitudes of a latitude-longitude quadrilateral in some embodiments, or the name of the country, city or street, or house number for another embodiment. In some embodiments, the definition field 253 also includes a list of properties: e.g., nearby GPS coordinate, map point of interest, place-name label, list of photos, among others, alone or in some combination. The parent ID field 255 holds data that indicates the node ID of the parent of the current node. For the root node, the parent ID field 255 is empty, omitted or holds a null value, in various embodiments. In some embodiments, some or all of the data in the definition field 253 is encrypted so that the SG server 150 does not know the kind of hierarchy or the actual values. In the illustrated embodiment, the level numbers and names field 257 holds data that indicates the predetermined levels of granularity, e.g., encrypted or un-encrypted names for each of the predetermined degrees of spatial granularity of the hierarchy. In some embodiments, the node definition field 253 holds a list of attributes or a rule, such as street number in the range from 900 to 999.

In some embodiments, a SG client 157 requests a copy of a portion of the hierarchy, e.g., all the sibling nodes and parent nodes up to the root node for one or more encrypted or un-encrypted values in the definition field 253 or node ID values for the node ID field 251. Thus the SG client 157 is not burdened with the entire hierarchy.

The node count history field 260 holds data that indicates the number of trails that pass through each node in the location granularity hierarchy during a particular time interval. Any time interval can be used, such as the minimum amount of time for UE to remain in a location or a multiple thereof. For example, in some embodiments, the counts are accumulated in one hour time intervals, which is a 360-fold multiple of a ten second minimum dwell time to be have a location entered into a trail for an entity. Node IDs that have counts of zero are not included in the node count history field 260 in some embodiments. Excluding zero count nodes is an example means of achieving the advantage of not wasting storage space on locations that have no counts.

In the illustrated embodiment, the node count history field 260 includes a node ID field 261, among others indicated by ellipsis, for each node with at least one time interval with at least one count. Each node ID field is followed by a time field and count field for each time interval that has at least one count, such as time fields 263a, 263b among others indicated by ellipsis (collectively referenced hereinafter as time fields 263), and count fields 265a, 265b among others indicated by ellipsis (collectively referenced hereinafter as count fields 265). As each trail location and time is reported to the SG service 150, the corresponding counts are incremented for the corresponding node and time interval, and ancestor nodes for the same time interval.

The group entry field 270 holds data that indicates criteria for a spatial context that defines a group of entities based on the trails for those entities. The criteria are often provided by a user of UE 101 using a SG user interface presented at the UE 101, as described in more detail below. In the illustrated embodiment, the group entry field 270 is included in the spatial groups data structure 240 for each group handled by the SG service 150. Other group entry fields 270 are indicated by ellipsis. In some embodiments, the group entry is provided with each request handled by the SG service. In some embodiment the SG service 150 maintains a catalog of previous group criteria in corresponding group entry fields 270.

In the illustrated embodiment, the group entry field 270 includes a group ID field 271, a recipient criteria field 273, and for one or more locations, a location node ID field and a time interval field. For example, group entry field 270 includes location node ID fields 275a and 275b, among other indicated by ellipsis (collectively referenced hereinafter as location node ID fields 275) and corresponding time interval fields 277a, 277b, among others indicated by ellipsis, respectively (collectively referenced hereinafter as time interval fields 277).

The group ID field 271 holds data that uniquely indicates an individual group entry field 270 among all the group entry fields 270 maintained in the spatial groups data structure 240. The recipient criteria field 273 holds data that is used to exclude entities from the group based on non-spatial properties, such as restrictions on gender or age or profile topics of interest, or some combination.

The location node ID field 275 holds data that indicates a location or node of the granularity hierarchy which constrains the trail of an entity to be included in the group. The location data is encrypted or un-encrypted in various embodiments. Similarly, the time interval field 277 holds data that indicates a time interval which constrains the trail of an entity to be included in the group. The time interval data is encrypted or un-encrypted in various embodiments.

The message context entries field 280 holds data that indicates a message to be shared with members of a group. In some embodiments, the message context entries field 280 is maintained by a network service 110, or not used; and field 280 is omitted from the spatial groups data structure 240. In the illustrated embodiment, the message context entries field 280 includes a message ID field and a group ID field for each message. For example, the field 280 includes message ID fields 281a, 281b, among other indicated by ellipsis (collectively referenced hereinafter as message ID fields 281), and corresponding group ID fields 283a, 283b, among others indicated by ellipsis, respectively (collectively referenced hereinafter as group ID fields 283).

The message ID field 281 holds data that refers to a message ID in field 211 of a message to be delivered to an entity that is a member of the group. Similarly, the group ID field 283 holds data that refers to a group ID in field 271 of a group entry field 270 that defines the membership in the group.

FIG. 2E is a diagram of a request message 290, according to an embodiment. In the illustrated embodiment, the request message 290 is directed to the SG service 150 from a network service 110 in response to a subscriber signing onto the service 110. The subscriber is identified to the service 110 and indicates a trail with encrypted or un-encrypted trail data. The service 110 wants to know if a particular message is to be sent to the subscriber signing on, based on the trail data. The request message 290 includes a subscriber information field 291, a subscriber trail field 293, a social level granularity field 295, a message or group ID field 297 and a social level field 299. In other embodiments, the messages or group IDs are determined differently and one or more of the fields in message 290 are omitted. For example, in some embodiments, the social level is replaced by a privacy level field holding data that indicates the level of sharing.

The subscriber information field 291 holds data that indicates non-spatial information about the subscriber signing on, such as the age, gender, or topics of interest from the subscriber's profile, or network address (such as an Internet Protocol, IP, address) where messages from the subscriber are originating.

The subscriber trail field 293 holds data that indicates the trail for the subscriber signing on to service 110, such as data in one or more fields depicted in trail data structure 220 that were passed from the SG client 157 to the service 110.

The social level granularity field 295 holds data that indicates the finest level of spatial granularity the subscriber is willing to acknowledge for a particular message that is owned by another subscriber who may or may not be in the subscriber's close social network, as described in more detail below. For example, a subscriber may be willing to share trail data at the building level with contacts or other friends, but only share city level information with subscribers who are not friends. This information is provided in field 295.

The message or group ID field 297 holds data that indicates the group criteria to be applied, either by giving the group ID directly in field 297 or indirectly by giving the message ID for an embodiment of the SG service 150 that maintains the message entries field 280.

The social level field 299 holds data that indicates the social relationship between the owner of the message and the subscriber. For example, the data indicates whether the subscriber and message owner are mutual contacts (e.g., friends) or not.

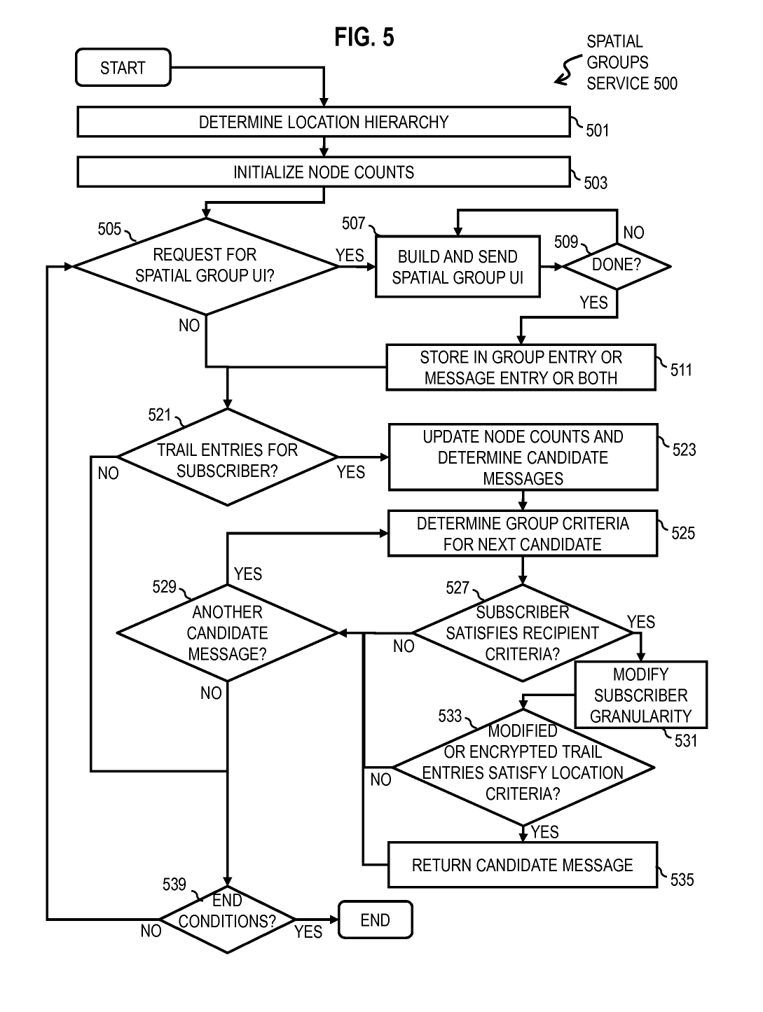

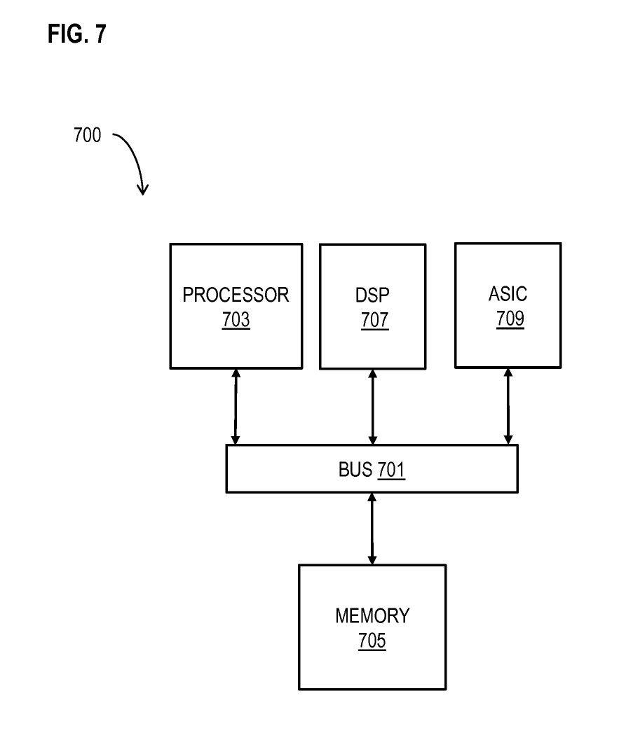

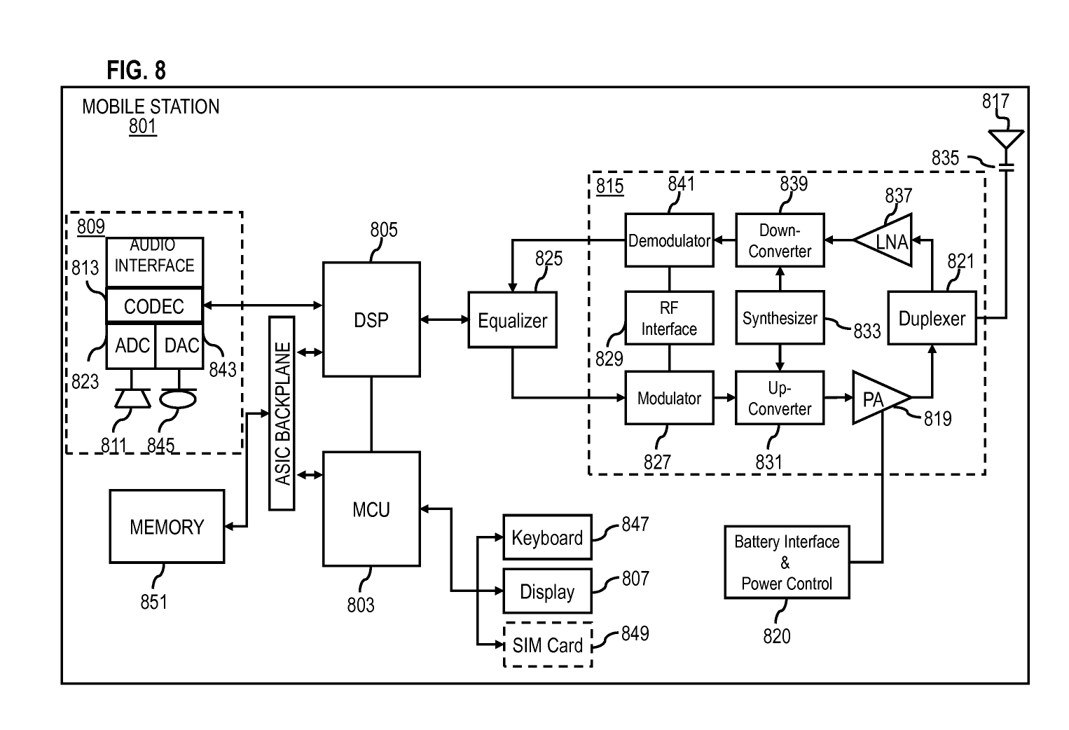

FIG. 3 is a flowchart of a process 300 for a spatial groups client, according to one embodiment. In one embodiment, the SG client 157 performs the process 300 and is implemented in, for instance, a chip set including a processor and a memory as shown in FIG. 7 or mobile terminal as depicted in FIG. 8. In some embodiments, one or more steps of process 300 are performed by the browser 107 or network service 110. Although steps are depicted in FIG. 3, and in subsequent flowchart FIG. 5, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 301, parameter values and encryption keys are determined. Parameter values indicate what location granularity hierarchy 230 is being used and the finest level of granularity to maintain in the trail for the user, among others, such as the minimum time to remain in a location (e.g., ten seconds) to record that location in the trail, and the oldest time to retain in the trail (e.g., two years) and the older time intervals to coalesce (e.g., combine data into time intervals of a week for entries older than a year). For example, using a hierarchy with a finest resolution at the room level within a building given by a street address, the user determines that the finest level to be maintained is a street level without a street number for the building. In some embodiments, step 301 includes presenting a user interface to the user to specify parameter values. In some embodiments, default values are used, e.g., a default hierarchy is used with the finest level of granularity in the hierarchy. In some of these embodiments, the user interface presented during step 301 allows the user to see and change the default values. In some embodiments, default values are used during step 301 and user over ride is allowed when other user interfaces are presented, as described in more detail below with reference to step 313.

The encryption keys are used for encrypting locations or times or both. In some embodiments, the encryption algorithms are homomorphic so that the encrypted values (ciphers) preserve the properties of hierarchical membership for encrypted locations or temporal order for time, or both. Homomorphic algorithms have been applied for calendaring applications and would apply to temporal order. In an example homomorphic algorithm for hierarchical membership, the definition of each node in the location granularity hierarchy is encrypted with a key for a one way keyed hash function. The key is kept at the SG client 157 but not revealed to the SG server 150, which maintains only ciphers in the definition field 253. Any method may be used to distribute the keys to the SG clients. For instance, public keys and certificates may be used to enable secure key distribution. In some embodiments, encrypted locations and times are not used.

In step 303 the current time and the current location of the UE 101 is determined for producing a trail entry. For example, periodically, e.g., after the minimum time to remain in a new location, a current position and time are obtained from the local context engine 103 on the same UE 101, either in response to a request sent by the SG client 157 or by the SG client 157 monitoring an output stream from the local context engine 103. The position is then converted to a location in the location granularity hierarchy at the finest granularity allowed by the user. For example, in various embodiments, a GPS position is truncated to fewer binary or decimal digits, or a GPS position is converted to a nearest street address or point of interest using a mapping or navigation application.

In some embodiments, the user has indicated that the finest granularity is a different level than the finest level of the granularity hierarchy being used; and, the hierarchy is followed to find the location value for the corresponding parent of the current location. In some of these embodiments, at least a portion of the hierarchy is downloaded from the SG server 150 so that this determination can be made. In embodiments using encrypted location values, the portion of the hierarchy requested is based on an encrypted value (cipher) of the location using the encryption key and homomorphic algorithm.

In step 305 the location or time is encrypted using a homomorphic encryption that preserves time order and membership in the location granularity hierarchy for the ciphers. In some embodiments, encryption is performed only when the trail is being sent over the communication network, and step 305 is performed during step 315, described in more detail below. In some embodiments, encryption is not used, and step 305 is omitted.

In step 307, any significant change in location is stored in the trail data structure. For example, if the location is the same as the last entry in the trail data structure 220, no entry is made. If the location is different from the value in the field 223 for the last entry and the time since the last entry in field 221 is not more than the minimum time (e.g., ten seconds), then the previous entry is deleted and replaced by a new entry with the current time in the start time field 221 and the current location in the location field 223 and the sent flag field 225 set to indicate not yet sent. If the location is different from the value in the field 223 for the last entry and the time since the last entry in field 221 is more than the minimum time (e.g., ten seconds), then a new entry is inserted in the trail data structure. The new entry includes the current time in the start time field 221 and the current location in the location field 223 and the sent flag field 225 set to indicate not yet sent.

In some embodiments, step 307 includes deleting the oldest entries from the trail data structure, or degrading the spatial or temporal granularity of the oldest entries that are retained, or some combination. For example, entries older than a predetermined time (e.g., two years) are deleted in some embodiments. In some embodiments, entries older than a predetermined time (e.g., one year) are averaged into predetermined time intervals (e.g., one week) and the finest granularity location that encompasses all positions during that time interval is used as the location, such as the city, country or continent in which all the locations during that time interval fall. In some embodiments, entries within additional predetermined times (e.g., between one day and one year) are averaged into additional predetermined time intervals (e.g., one hour) and the finest granularity location that encompasses all positions during that time interval is used as the location. In some embodiments, the hierarchical node that encompasses all locations in the time interval is not used, and instead a typical location at the target level of granularity is used, such as a location most frequently occupied in the time interval or the location occupied at the first, last or predetermined intermediate time, such as at a time in the midpoint of the time interval.

FIGS. 4A-4B are diagrams that illustrate trail data, according to various embodiments. FIG. 4A is a graph 410 that illustrates example trail data, according to an embodiment. The horizontal axis 402 is time before present, with more recent times expanded compared to more distant times. For example, in some embodiments, axis 402 is a reversed logarithmic axis of time before present. In the illustrated embodiment of axis 402, the last minute occupies the same distance as the previous ten minutes, or the 50 minutes before that, or the 5 hours before that, etc., until a time 5 years before the present is reached. Location entries older than 5 years are removed from the trail in the illustrated embodiment. In other embodiments, locations of different ages are removed from the trail. The vertical axis 404 indicates the level of spatial granularity with which the location values are stored.

The trace 412 indicates the spatial resolution of the location values in the stored trail data. In the illustrated embodiment, the locations for the last six hours are recorded with room level granularity; and, the locations for last year (except for the last six hours) are recorded with building level granularity (e.g., as street name and number). The locations for the four years before that are recorded at the city level. Changing the spatial granularity back in time saves resources because changes between locations at the coarser granularity typically occur less often and involve many fewer entries. In other embodiments, spatial granularity is not changed and device resources are preserved by dropping entries that are less old, e.g., dropping entries older than about six months. In some embodiments, the time is relative to a moving time, such as the current time, rather than a fixed past absolute time.

At any time along the axis 402 the location of the trail is provided at the level of granularity indicated by trace 412. For example, at trail entry 414a that covers a time 4 months before present, the location is available at the building level. In the illustrated embodiment this location is given as ABC Coffee Shop on 123 Main Street in City X of Country X. Similarly, at trail entry 414b that covers a time one day before present, the location is also available at the building level. In the illustrated embodiment this location is given as XYZ Bank on 45 Oak Avenue in City Y of Country X (same country, different city).

FIG. 4B is a graph 420 that illustrates example trail data, according to another embodiment. In this embodiment, all locations within an ever expanding time interval are combined to show how the location granularity hierarchy is able to accommodate different locations within a time interval. The horizontal axis 402 and vertical axis 404 are as described above. The trace 422 indicates the finest granularity location that encompasses all locations within a combined time interval. For example, because the trail indicates two different buildings in two different cities in the time interval from 3 days to 1 day before present, the location granularity that encompasses both locations is the region level; and the value for the region level location in that time interval is the name of the region that encompasses both City X and City Y. It is assumed for purposes of illustration that in the time interval from 5 years to 1 year before present, the trail included locations in different countries and therefore the world level of granularity encompasses both. The world level is the root level of the hierarchy and contains only one value=“The World.”

Thus, in various embodiments, data like that illustrated in FIG. 4A or FIG. 4B is stored in the trail data structure 220 during step 307.

In step 309, a service is started that supports spatial groups. For example, through the browser 107, a user logs on or subscribes to social network service 110n which supports spatial groups for sharing messages including text, photos, audio clips, games and other applications. In step 311, it is determined if the user wishes to set spatial group preferences, such as level of spatial granularity to share among various social groups. If so, then in step 313, the user sets and sends the level of granularity to be shared with various social groups, such as a finest level for close friends, and coarser level for contacts or family who are not friends, and a coarsest level for other subscribers of the service 110n who are not contacts of the user registering (or the subscriber logging on subsequently). In some embodiments, step 313 includes presenting a spatial group user interface (UI) obtained by the service 110n from the SG service 150, e.g., through the API 151, and sent to the SC client 157 or browser 107 by the service 110n. The spatial groups UI is described in more detail below with reference to step 321.

If the user does not set preferences in step 311, or after the preferences are sent during step 313, then in step 315 at least the most recent trail entries from the local trail data structure are sent to the service. In embodiments in which the network service 110 or SG service 150 stores the trail data for the subscriber, only the trail entries marked as not yet sent in sent flag field 225 are sent. In other embodiments, more or all of the trail entries in the trail data structure are sent. In some embodiments, only encrypted locations, or times, or both are sent during step 315. In such embodiments, if encrypted values are not stored in the local trail data structure 220, then, during step 315, the locations or times or both retrieved from the trail data structure 220 are encrypted before sending using the key received in step 301 and the homomorphic algorithm.

In step 317, shared data, such as one or more messages, identified based, at least in part, on the subscriber's trail is received and presented on the local device, either by the SG client 157 or the browser 107 or a client process (not shown) of the service 110. Thus data associated with groups of which the subscriber is a member by virtue of the trail for the subscriber are received during step 317.

In step 319, it is determined whether the subscriber wishes to describe a spatial context to define a group based on trail data. If not, then in step 331 it is determined if end conditions are satisfied. For example, it is determined if the SG client 157 is closed down. If so, then the process ends. Otherwise, control passes back to step 303 and following, described above.

If it is determined, in step 319, that the subscriber wishes to describe a spatial context to define a group based on trail data, then control passes to step 321. In step 321a spatial group user interface is presented. In some embodiments, the spatial group interface indicates the subscriber's own trail. In some embodiments, the user interface is a text-based or audio based interface. For example, places are defined by place-names and are recognized through speech or text. For example: “I′d like to send a message to the people who were at both the Cambridge and Palo Alto labs of my company in the past week.” In an illustrated example embodiment, the user interface is a graphical user interface (GUI). In some embodiments, there is a widget or web application or it is linked to some existing widget or web application in user's device. In some embodiments, one or more elements of the UI are determined at the service 110 or SG service 150 in response to user input to the user interface. In such embodiments, step 321 comprises exchanging one or more messages with the service 110 or SG service 150.

FIGS. 4C-4F are diagrams of user interfaces utilized in the processes of FIG. 3, according to various embodiments. FIG. 4C is a diagram that illustrates an example screen 460 on a display device of UE 101, according to one embodiment. The screen 460 includes one or more active areas that allow a user to input data to operate on trail data. As is well known, an active area is a portion of a display to which a user can point using a pointing device (such as a cursor and cursor movement device, or a touch screen) to cause an action to be initiated by the device that includes the display. Well known forms of active areas are stand alone buttons, radio buttons, check lists, pull down menus, scrolling lists, and text boxes, among others. Although areas, active areas, windows and tool bars are depicted in FIG. 4C through FIG. 4F as integral blocks in a particular arrangement on particular screens for purposes of illustration, in other embodiments, one or more screens, windows or active areas, or portions thereof, are arranged in a different order, are of different types, or one or more are omitted, or additional areas are included or the user interfaces are changed in some combination of ways.

The screen 460 includes time axis 402 and spatial granularity axis 404, as described above. The screen also displays one or more trail entries of an initial trail, such as the trail for the user of UE 101 or some hypothetical trail retrieved from a trail data structure. Thus, screen 460 is a user interface that indicates the first trail in a first dimension and spatial granularity in a different second dimension. It is assumed for purposes of illustration that the user's own trail is the same as trace 412 depicted in FIG. 4A. The screen includes one or more slide bars 467 that indicate by a horizontal open box the degree of spatial granularity to be shared with other users of the service. In the illustrated embodiment, the slide bar 467a indicates that a street level spatial granularity can be shared with a first level of social association (e.g., friends and contacts). The slide bar 467b indicates that a city level spatial granularity can be shared with a second level of social association (e.g., subscribers of service 110 who are not contacts or friends of the user of the device on which the screen 460 is presented). In other embodiments, more or fewer social level slide bars are included; for example, a third slide bar is included for close friends of the user or individuals, as determined by the subscriber profile at service 110 for the user. The screen 460 also includes a group button 269 which is activated to indicate criteria for defining the group, or individual, as described in more detail below.

The area bounded by the axes 402 and 404 is an active area that can be activated by a pointing device, as represented by the cursor arrow 406. User makes a (category) search by selecting time along time axis 402 (even though the time is exact the search may cover also plus minus 1 hour or any other time interval in various embodiments). When the pointing device is positioned along the trace 412 at that time, a trail entry window 462 is opened in the trail screen 460. The trail entry window 462 includes text that indicates the entry (e.g., ABC Coffee House 123 Main Street, City X, Country X) and one or more button active areas. The cursor is moved along the trace 412 to select the location of interest, e.g., the user selects the place, e.g. (Sturmstrasse 50, Berlin, Germany). In the illustrated embodiment, the active areas in the window 462 include a delete button 463, a degrade button 464, a select button 465, and a map button 466. In other embodiments, more or fewer buttons are included in the window 462.

When the delete button 463 is activated, the entry is deleted from the trail data structure 220, including deleting the start time field 221, location field 223 and sent flag field 225 associated with the entry. When the degrade button 464 is activated, the spatial granularity is made coarser by one level. For example, the entry removes the “ABC Coffee House” and street number “123”. The entry is degraded to the street level, which would then read “Main Street in City X in Country X.” The value stored in the location field 223 of the trail data structure is changed.

The user can also use the interface to limit the amount of time covered in the past; and, in response, the SG client 157 drops old (expired) data automatically. The level of expiration could be end-user (creating user) controlled. As shown with the delete button, the user can operate the UI to deselect himself from a given place. This would exclude him from being in groups that would include that place. This change could be retroactive in the sense that an old location is deleted, or proactive (e.g., never include place X).

When the select button 465 is activated, the entry is selected for use in defining a group criterion for a spatial group based on trail data (also called a spatial context). When the map button 466 is activated, a map interface is provided to better distinguish the spatial locations that might be hard to find in the trail screen 460. FIG. 4G is a diagram that illustrates an example select location screen 470 on a display device of UE 101, according to one embodiment. The screen 470 includes map landmarks, such as roads 472. The screen 470 also displays one or more selected trail entries, e.g., trail entries 484a, 484b, 484c (collectively referenced hereinafter as trail entries 484) of an existing trail, such as entries selected in screen 460, as described above. To avoid cluttering the diagram, only three entries of the trail are depicted in FIG. 4G connected by a dashed line 480. A route between the locations is not explicitly stored, but could be inferred from the dashed line and the road locations on the map. The screen 430 also includes a select button 474 active area and done button 476 active area. A location is selected by positioning the cursor 406 on a location and then pressing the select button. The portion of the map presented is controlled by map controls 478, such as scroll direction controls. After locations are selected using the map interface, control returns to screen 460 by activating the done button 476.

When the group button 469 is activated, the selected entries are used to define a spatial context. FIG. 4D is a diagram that illustrates an example define spatial group screen 430 on a display device of UE 101, according to one embodiment. The screen 430 includes time axis 402 and spatial granularity axis 404, as described above. The screen also displays one or more selected trail entries of an existing trail, such as entries selected in screen 460, as described above. To avoid cluttering the diagram, only two entries of the trail are depicted in FIG. 4C, entry 414a at a time about 4 months before the present and entry 414b at a time about one day before the present, the same entries indicated in FIG. 4A. The screen 430 also includes a restrict button 431 active area and done button 433 active area, described in more detail below with reference to FIG. 4E.

For each entry selected to define a group, a location label display area is presented that presents the location value of the selected entry, e.g., “ABC Coffee House at 123 Main Street in City X of Country X,” or some shortened version thereof (such as “ABC Coffee House on Main”), including location label 438a and 438b (collectively referenced hereinafter as location labels 438) for trail entries 414a and 414b, respectively.

The screen 430 also depicts around each selected entry an unfilled circle 432a and 432b (collectively referenced hereinafter as open circles 432) surrounding entry 414a and 414b, respectively. A radius of the open circle is related to the number of entities that share that trail entry, such as the number of subscribers of the service 110 who include that entry in their trail data. The larger the number of entities, the larger the radius. In some embodiments the radius is logarithmic to avoid becoming unmanageably large or imperceptibly small. The screen 430 also depicts, around each selected entry, a filled circle. A radius of the filled circle is related to the number of entities that share all or most of the selected trail entries, at least approximately. It is assumed for purposes of illustration that there are an insufficient number of entities (e.g., less than a minimum number such as five or ten entities) to define a filled circle for the two selected trail entries.

To increase the size of the group, the user may degrade the granularity of the spatial context by sliding the entry vertically to select a coarser spatial granularity and thus cast a wider net for matches. The area of screen 430 bounded by the axes 402 and 404 is an active area that can be activated by a pointing device, as represented by the cursor arrow 406. When the pointing device is positioned at an entry and then moved in a vertical direction, the entry moves with it to a different degree of spatial granularity. Moving the granularity to a coarser level is expected to both widen the open circle for the moved entry and increase the membership in the group as indicated by the filled circle. Thus, a spatial granularity of the criterion is coarser than a spatial granularity of the first trail at the first time.

FIG. 4E is a diagram that illustrates an example define spatial group screen 440 on a display device of UE 101, according to one embodiment, after an entry has been moved vertically in the dimension of changing spatial granularity. Thus the first spatial granularity of the criterion is based on input in the active area along the second dimension. The screen 430 includes time axis 402 and spatial granularity axis 404 and trail entry 414a and open circle 432b around trail entry 414b, as described above. The screen 440 also includes a restrict button 431 active area and done button 433 active area.

The screen 440 also depicts the new spatial granularity of entry 414a as the center of larger radius open circle 442a indicating the city level of spatial granularity. The location label 448 holds data that indicates City X. The open circle 442b indicates the number of entities in the coarser spatial location, e.g., the number of subscribers in City X at that time on that date four months ago. The filled circle 444a indicates the number of entities that match both entries to the specified degree, e.g., the number of subscribers who were in or near City X four months ago and in or near XYZ Bank in City Y yesterday. The filled circle 444b at entry position 414b is the same size as filled circle 444a and indicates that entry 414b also defines the group. Thus, the user interface further indicates a number of entities based on the spatial granularity changed in the active area.

When the restrict button 431 is activated, the user is given the option to further restrict membership in the group based on non spatial information associated with the entities, such as age or gender or some combination. FIG. 4F is a diagram that illustrates an example graphical user interface 450 for selecting non-spatial restrictions criteria for the group. The GUI 450 comprises a circle that represents the entities in the group based on spatial context, such as in filled circle 444a or 444b. Each wedge 452a, 452b, 454a and 454b indicates a subset of that group that satisfies additional criteria, at least approximately. For purposes of illustration, it is assumed that the additional criteria are gender and age. The males are represented by wedges 452a and 454a; the females by wedges 452b and 454b. The males under age twenty five are represented by wedge 452a, and over twenty five by wedge 454a. Similarly, females under age twenty five are represented by wedge 452b, and over twenty five by wedge 454b. The user selects further restrictions by using the pointing device, such as cursor 406, to select one or more of the wedges. When the selection is made, e.g., for wedge 452b, screen 440 is returned with possibly a smaller filled circle replacing filled circle 444a and 444b. When the done button 433 is activated, the final criteria for the group are determined.

Note that because the change in granularity has not changed the location, the original trail is still a match for the group. Furthermore, if the original trail represents the user's own trail, then the user is a member of the newly defined group. An advantage of restricting groups to those that include the entity defining the group is to reduce intrusions on the privacy of other entities with whom the user has weak or no association.

Thus a graphical user interface is presented during step 321. In step 323 it is determined if user input is received. For example it is determined whether the user has selected one or more entries from the trail or changed spatial granularity for one or more social levels in screen 460, or moved an entry vertically or activated the restrict button 431 or done button 433 in screen 430 or screen 440. If not, control passes to step 331, described above, to determine if end conditions are satisfied. If user input is received, then in step 325 the group and or message is determined. The message is determined in one or more well known message user interfaces, such as a window on a display with a text box and a file browse box and a submit button. The size of the group for given interim group criteria is also determined during step 325, for example, by exchanging one or more messages with the SG service 150, either directly or indirectly through the service 110, to determine the counts from node count history data structure 260. The breakdown by gender or age or other non-spatial properties, such as the values for the properties (e.g., places that have photos) associated with a location in the definition field 253, is determined, for example, by exchanging one or more messages with the service 110 which accesses that information in the subscriber profiles.

In step 327, it is determined whether the definition of the spatial group criteria is finished, e.g., whether the done button 433 has been activated. If not, control passes back to step 323 to await further user input. If so, then in step 329 the group criteria is sent to the SG service 150, either directly or indirectly through the network service 110. In some embodiments, step 329 includes sending the message to be shared with members of the group to the service 110. Control then returns to step 319, described above, to determine if another spatial group is to be defined.

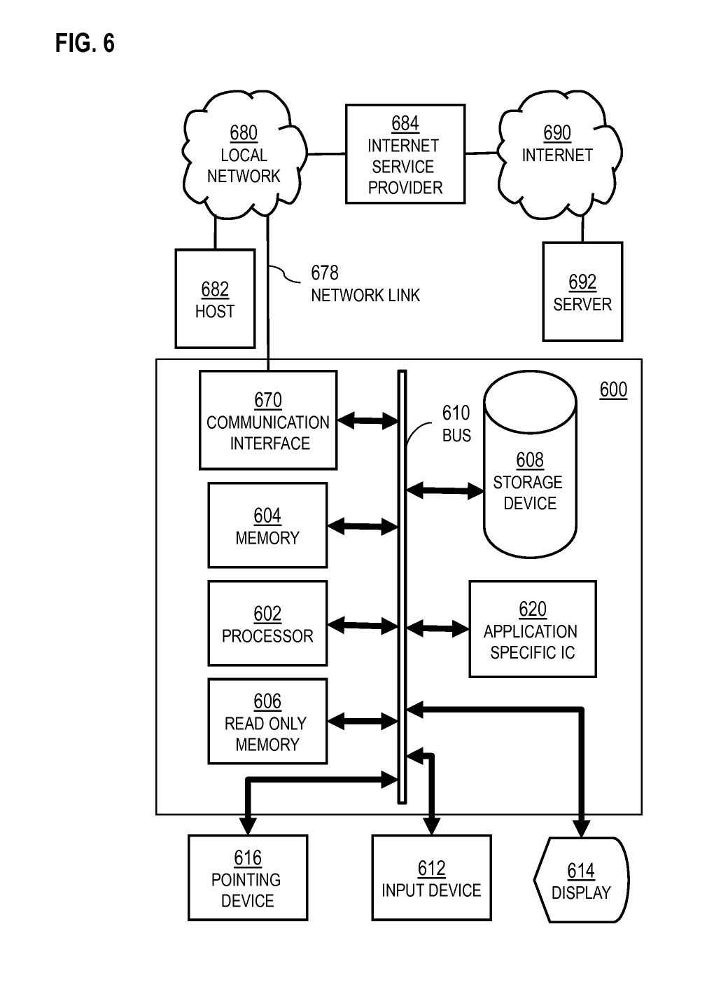

FIG. 5 is a flowchart of a process 500 for a spatial groups service, according to one embodiment. In one embodiment, the SG service 150 performs the process 500 and is implemented in, for instance, a chip set including a processor and a memory as shown in FIG. 7 or general purpose computer as depicted in FIG. 6. In other embodiments, one or more steps of process 500 are performed by the service 110 or SG client 157 or by script installed in browser 107, among other components, or some combination.

In step 501 the location granularity hierarchy is determined and stored in hierarchy field 250. Any method may be used to determine the hierarchy. In some embodiments, the hierarchy is read from local data storage or retrieved from a local or remote database, or is sent by another process on the same or different host, whether unsolicited or in response to a request. Any method may be used to express the hierarchy, such as an explicit listing of values at each node, or a rule based hierarchy, e.g., based on latitude and longitude quadrangles. In some embodiments, the values in the node ID fields 251 and parent ID fields 255 and level numbers and names field 257 are known, but the values in the definition field 253 are ciphers that cannot be decrypted by the process 500.

In step 503 node counts are initialized. For example, the count in every node is initially zero and there are no fields in the node count history field 260. In some embodiments, step 503 include periodically removing some count entries, such as removing all time field 263 and corresponding count field 265 from the field 260 for times before a predetermined oldest retained time, such as five years before present.

In step 505 it is determined whether a spatial group user interface is requested. For example, it is determined that a message is received from service 110n for the SG user interface. Such a request may be sent by the service 110 when a subscriber wants to associate a service with a group of subscribers based, at least in part, on their trails. In another embodiment, a client launches a SG client 157, on their device, either directly or indirectly through a client of service 110 or browser 107, which sends a message asking for the SG user interface.

If a SG user interface is requested, then in step 507 the spatial group user interface, such as the spatial group GUI screen 460, is built and sent. The SG user interface then reads the trail data structure on the user equipment and displays the trail, as in screen 460. Thus step 507 includes determination of a first trail comprising a plurality of locations of finite spatial granularity at a corresponding plurality of time.

The user interface is updated with any data in response to user input. For example, in response to user input indicating a group is to be defined based on one or more trail entries, e.g., by activating the group button 469, the count for the nodes that match the encrypted or unencrypted location values are returned. In some embodiments in which the SG service 150 retains all trails in multiple trail data structures 220, the SG service 150 can also determine how many, or what percentage, of those counts are from trails that pass through or close to most or all selected locations and thus determine the radius of the filled circles for screens 440 of the GUI. This can be done even if the entity whose locations are described by the trail is not known and if the location values are encrypted by a homomorphic algorithm. If some non-spatial data about the subscriber is known, then data to produce GUI 450 can also be determined and sent during step 507. Thus determining data that indicates at least one criterion in step 507 includes causing, at least in part, actions that result in presenting a user interface on a device. The user interface indicates the first trail and an active area that allows spatial granularity to be changed for at least the first location at the first time.

In step 509, it is determined if the user input through the user interface is completed, e.g., by activation of the done button 433. If not, control passes back to step 507 to update and send the UI. If the group criteria are completed, then, during step 511, the group criteria are stored in the group entry field 270. For example, a new group number, or human-readable name, is generated to use as a group ID that is stored in field 271. The group criteria include the same or changed location granularity for the location and time entries in the original trail. Thus step 509 includes a determination of at least one criterion for belonging in a group, wherein the criterion indicates a first spatial granularity for at least a first location at a corresponding first time in the first trail.

In some embodiments, groups that person A has defined are made public and/or shared for others to use, including being sold, auctioned, or given away (although the people in the group might change slightly as a result—based on their privacy choices. In some embodiments, implicit or predefined groups are distributed to a user on their mobile device, e.g., my contacts/friends list is automatically populated with other users that have 80% of a trail overlap with me at a specified granularity (e.g., at building-level granularity).

The non-spatial criteria, such as gender and age, if any, are recorded in the recipient criteria field 273. The location node ID of the encrypted or unencrypted location value is stored in the location node ID field 275 and the encrypted or unencrypted time is stored in time interval field 277 for each location used to define the group. This determines the spatial context for the group, regardless of how that context is used.

If a message or other data is to be sent to members of the group, then the message ID of the message or other data associated with the group is stored in the message ID field 281 of the message context entries field 280 and associated with the group ID by storing the group ID in the corresponding group ID field 283.

After step 511, or if a request for the spatial group UI is not received, then, in step 521, it is determined whether a trail for a subscriber is received. For example, request message 290 is received that includes subscriber trail data in subscriber trail field 293. In some embodiments, the network service 110 maintains a catalog of all messages and associated group IDs in message context entries field 280, and the request message 290 is sent by the service 110 for each message stored by the service 110 each time a subscriber logs into the service and sends a recent trail for the subscriber. The service 110 indicates the group ID in field 297. In some embodiments, the request message is sent each time a subscriber logs in, but the SG service 150 maintains a catalog of all messages and associated group IDs in message context entries field 280. In various embodiments, the service 110 indicates the message ID in field 297, or all messages are checked and field 297 is omitted.

In some embodiments, the service 110 knows the social relationship between the subscriber whose trail is in field 293 and the owner of the message; and the service 110 indicates whether the social level between the two subscribers, e.g., level 1 for close friends, level 2 for just contacts, or level 3 for just subscribers with no direct contact. This relationship is indicated in the request message 290 in social level field 299. If the subscriber, whose trail is provided in field 293, has defined different levels of granularity to be used for different social levels, e.g., using slide bars 467, then that information is indicated in the social level granularity field 295. This information is used to degrade the spatial granularity of the trail data in field 293 before comparing the trail to the spatial criteria for the group. If the group includes non-spatial recipient criteria, then the values of those parameters are included in subscriber information field 291 for the subscriber whose trail is in field 293. In some embodiments, the service 110 returns the message to the subscriber. In some embodiments, the SG service 150 returns the message; and in such embodiments the subscriber information field 291 includes the network address (such as the IP address) of the device to receive the message.

If it is determined in step 521 that trail entries for a subscriber are not received, then control passes to step 529 to determine if end conditions are satisfied, such as the SG service 150 is shutting down. If so, the process ends. Otherwise control passes back to step 505 described above.

If it is determined in step 521 that trail entries for a subscriber are received, then in step 523 the trail entries not previously sent (as indicated by the sent flag field 225) are used to update the counts in one or more nodes of the location granularity hierarchy. When a count for a child node is incremented, the counts of all its ancestor nodes for the same time are also incremented. This can be done even if the location definition field 253 holds ciphers or if the time is a cipher—provided the encryption is homomorphic for such operations.

In some embodiments, the SG service 150 maintains a trail data structure 220 for all encountered trails. In such embodiments, such trail data structures are updated by adding the entries not previously sent and, in some embodiments, deleting entries older than a particular time or before a particular ciphered time. Determining which data structure to update can be accomplished in any manner, e.g., by matching all the previously sent entries, or by using a unique pseudonym for each subscriber provided by the service 110 in the subscriber information field 291. Thus step 523 includes determining a second trail for a particular entity, e.g., the subscriber whose trail is indicated in field 293. In some embodiments, the first trail is a trail for a different entity from the particular entity. The different entity defined the group criteria based on the different entity's own trail and input to the user interface. Thus the at least one determination of data that indicates the at least one criterion is based on input from the different entity.

In some embodiments, the non-spatial characteristics of the subscriber that were compared to the recipient criteria are stored in association with the trail data structure 220 for each subscriber. Thus, the size of groups can be determined during the building and sending of the spatial groups user interface, in step 507, described above.

Step 523 also includes determining candidate messages to check. For example, the messages indicated in the message context entries field 280 for the particular service (e.g., messages of service 110n) are candidate messages. In some embodiments, the request message 290 indicates one or more messages in field 297, and those messages are the only candidate messages. In some embodiments, no message is involved, and the request 290 is merely to determine whether the subscriber whose trail is provided satisfies the criteria for the group or groups indicated in field 297. In some embodiments, several messages are associated with the same group criteria. In some of these embodiments, the messages are sorted by associated group ID and all messages with the same group ID are processed together. Thus, step 523 includes determination of a message to be shared with entities that belong to the group.

In step 525, the group criteria for the next candidate message, or group, is selected. In step 527 it is determined if the subscriber whose trail data has been received satisfies the recipient criteria, if any. For example, the gender and age in subscriber information field 291 is compared to the gender and age restrictions in the recipient criteria field 273 for the selected group. If not, the subscriber is not a member of the group. Thus in step 527, determining whether the particular entity belongs in the group includes determining whether the particular entity belongs in the group based at least in part on non-location data associated with the particular entity. If not a member of the group, control passes to step 529 to determine if there is another candidate message or group. If not, control passes to step 539 to check for end conditions, as described above. If so, control passes back to step 525 to select the next group ID to check.

If it is determined, in step 527, that there are no recipient criteria or that the subscriber whose trail data has been received satisfies the recipient criteria, then control passes to step 531. In step 531 the granularity of the trail data is modified, based on the social level indicated in field 299 and the social level granularity indicated in field 295. For example, if the owner of the message is at a second social level (e.g., contact but not friend), then the finest resolution trail data is not allowed to be finer than the level two slide bar, (e.g., street level, without street number or building indicator). Any building or room information is degraded to street level granularity. This can be done even if the actual location value is encrypted homomorphically in the trail and in the definition field 253 of the hierarchy field 250.

In step 533, it is determined if the modified or encrypted trail values, or both, satisfy the criteria. Any degree of satisfaction may be used. In some embodiments an exact match is required, e.g., at least one trail value must fall within every location included in the group entry field 270. In other embodiments, approximate matches are acceptable; for example, a location within 10 percent of the location or time specified in the group entry field 270 satisfies the criterion. In some embodiments, fuzzy logic is used to determine if the criteria are satisfied. For example, a trail location and time within 90 percent of the locations specified in the group entry field 270 satisfies the criteria. Thus, step 533 includes determination of whether the particular entity belongs in the group based, at least in part, on the criterion and the second trail for the particular entity.

In step 535 the candidate message or messages associated with the group criteria are sent to the subscriber whose trail was indicated in field 293. In some embodiments in which the IP address of the subscriber has been provided and the SG service 150 maintains the message field 210, the SG service 150 sends the message or other data. In other embodiments, the SG service 150 returns a success message or list of message IDs to the service 110 to indicate that the subscriber is a member of the group, and the service 110 sends the message or messages or other data to the UE 101 of the subscriber. Thus, step 535 includes causing, at least in part, actions that result in the message being sent to the particular entity, if the particular entity is determined to belong in the group. Control then passes to step 529, as described above.

Using these methods, many new capabilities are provided. For example, if you forget a scarf in a railway station, now you can send a message, with a time location tag, to all those subscribers of a social network service who were on the railway station in the same time window as you. Neither you nor the recipient will know the people on the list. You will not know the people who match the criteria and they can answer without knowing who you are. In this way, these methods are used for private location-based social messaging. With homomorphic encryption, even the SG service 150 does not know the locations of the users and subscribers. Another example is to specify the group of people who were in the US last week, but are now in Finland.

Similarly, a user can start writing the text: “I lost my cell phone (make and model). Have you seen it? Please kindly answer this message by reply option if you have seen it.” User sends it to the service along with a definition of the group of persons who were at the Sturmstrasse 50, Berlin, Germany, within a few hours of when the user was last there. The service selects the group of persons (whom the user does not know) which match that time in that place (they have been tracked). Any of the matched persons in the group can then answer anonymously to the user who has lost his cell phone. For example, a person of the group who found the phone sends a message to the user that the phone is found, all without revealing the user or the person who found the phone. Another example might be that the user has met a person in a particular airport on a given date and time and talked with him without getting his contact information. If the user wants to send a message to meet someplace, the user indicates the time and place of the airport meeting and sends a message using one or more of the services described above.

Thus the service provides the capability to: (a) track users, (b) group users based on their tracks (locations), and (c) send messages between people anonymously based on their group membership. The system can also limit who can send messages to whom; for example, you could only send messages to groups that you are a member of.

The processes described herein for determining context based on a spatial trail may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to determine context based on a spatial trail as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of determining context based on a spatial trail.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to determine context based on a spatial trail. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for determining context based on a spatial trail. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for determining context based on a spatial trail, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for sending context based on a spatial trail to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to determine context based on a spatial trail as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of determining context based on a spatial trail.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to determine context based on a spatial trail. The memory 705 also stores the data associated with or generated by the execution of the inventive steps.

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of determining context based on a spatial trail. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of determining context based on a spatial trail. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to determine context based on a spatial trail. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of a first trail comprising a plurality of locations of finite spatial granularity at a corresponding plurality of times;
at least one determination of at least one criterion for belonging in a group, wherein the criterion indicates a first spatial granularity for at least a first location at a corresponding first time in the first trail; and
at least one determination of whether a particular entity belongs in the group based, at least in part, on the criterion and a second trail for the particular entity, wherein a trail for any entity comprises a plurality of locations of finite spatial granularity indicating actual locations of the entity at a corresponding plurality of times.

2. A method of claim 1, wherein the first spatial granularity is coarser than a spatial granularity of the first trail at the first time.

3. A method of claim 1, wherein the finite spatial granularity is selected from a plurality of predetermined finite spatial granularities.

4. A method of claim 1, wherein the finite spatial granularity is selected to provide a degree of privacy for the entity.

5. A method of claim 1, wherein the plurality of locations with or without times in any trail and the first location in the criterion are encrypted with a homomorphic encryption that preserves membership in locations or times of finer or coarser granularity.

6. A method of claim 1, wherein the (1) data and/or (2) information and/or (3) at least one signal are further based, at least in part, on the following:
at least one determination of a message to be shared with entities that belong to the group; and
causing, at least in part, actions that result in the message being sent to the particular entity, if the particular entity is determined to belong in the group.

7. A method of claim 1, wherein determining data that indicates at least one criterion further comprises causing, at least in part, actions that result in presenting a user interface on a device, wherein the user interface indicates:
the first trail; and
an active area that allows spatial granularity to be changed for at least the first location at the first time.

8. A method of claim 7, wherein.
the user interface indicates the first trail in a first dimension and spatial granularity in a different second dimension; and
the first spatial granularity is based on input in the active area along the second dimension.

9. A method of claim 7, wherein the user interface further indicates a number of entities based on the spatial granularity changed in the active area.

10. A method of claim 1, wherein determining whether the particular entity belongs in the group further comprises determining whether the particular entity belongs in the group based at least in part on non-location data associated with the particular entity.

11. A method of claim 1, wherein the first trail is a trail for a different entity from the particular entity.

12. A method of claim 11, wherein the at least one determination of data that indicates the at least one criterion is based on input from the different entity.

13. An apparatus comprising:
at least one processor; and
at least one memory including computer program code for one or more programs,
the at least one memory and the computer program code configured to, with the at least one processor, cause the apparatus to perform at least the following,
determine data that indicates a first trail comprising a plurality of locations of finite spatial granularity at a corresponding plurality of times;
determine data that indicates at least one criterion for belonging in a group, wherein the criterion indicates a first spatial granularity for at least a first location at a corresponding first time in the first trail; and
determine whether a particular entity belongs in the group based, at least in part, on the criterion and a second trail for the particular entity, wherein a trail for any entity comprises a plurality of locations of finite spatial granularity indicating actual locations of the entity at a corresponding plurality of times.

14. An apparatus of claim 13, wherein the plurality of locations with or without times in any trail and the first location in the criterion are encrypted with a homomorphic encryption that preserves membership in locations or times of finer or coarser granularity.

15. An apparatus of claim 13, wherein to determine data that indicates at least one criterion further comprises to cause, at least in part, actions that result in presenting a user interface on a second apparatus, wherein the user interface indicates:
the first trail; and
an active area that allows spatial granularity to be changed for at least the first location at the first time.

16. An apparatus of claim 15, wherein.
the user interface indicates the first trail in a first dimension and spatial granularity in a different second dimension; and
the first spatial granularity is based on input in the active area along the second dimension.

17. An apparatus of claim 15, wherein the second apparatus is a mobile terminal comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
determine data that indicates a first trail comprising a plurality of locations of finite spatial granularity at a corresponding plurality of times;
determine data that indicates at least one criterion for belonging in a group, wherein the criterion indicates a first spatial granularity for at least a first location at a corresponding first time in the first trail; and
determine whether a particular entity belongs in the group based, at least in part, on the criterion and a second trail for the particular entity, wherein a trail for any entity comprises a plurality of locations of finite spatial granularity indicating actual locations of the entity at a corresponding plurality of times.

19. A computer-readable storage medium of claim 18, wherein the plurality of locations with or without times in any trail and the first location in the criterion are encrypted with a homomorphic encryption that preserves membership in locations or times of finer or coarser granularity.

20. A computer-readable storage medium of claim 18, wherein to determine data that indicates at least one criterion further comprises to cause, at least in part, actions that result in presenting a user interface on a second apparatus, wherein the user interface indicates:
the first trail; and
an active area that allows spatial granularity to be changed for at least the first location at the first time.

21.-52. (canceled)
